(19) United States
(12) Patent Application Publication
(10) Pub. No.: US 2024/0001801 A1
(43) Pub. Date: Jan. 4, 2024

(54) POWERTRAIN FOR AN ELECTRIC VEHICLE FEATURING A SCALABLE AND MANAGEABLE ENERGY STORAGE SYSTEM

(71) Applicant: Blue Volta Technology Inc., San Jose, CA (US)

(72) Inventors: Louay ALSAKKA, Cupertino, CA (US); Maxim MOISEEV, Santa Clara, CA (US)

(73) Assignee: Blue Volta Technology Inc., San Jose, CA (US)

(21) Appl. No.: 18/253,112

(22) PCT Filed: Nov. 18, 2021
(86) PCT No.: PCT/US2021/072487

§ 371 Date: May 16, 2023

Related U.S. Application Data
(60) Provisional application No. 63/115,236, filed on Nov. 18, 2020.

(51) Int. Cl. B60L 58/18; B60L 7/10; H01M 10/44; H01M 10/48; H01M 10/42

(52) U.S. Cl. CPC B60L 58/18; B60L 7/10; H01M 10/441; H02J 7/0063; H01M 10/425; B60L 2240/42; H01M 10/482

(57) ABSTRACT

An electric vehicle powertrain is disclosed. The powertrain includes an electric motor electrically coupled to an energy storage system That includes a motor control unit to determine a phase of the electric motor and a plurality of cells to determine a discrete power output based, at least in part, on the determined phase of the electric motor; and generate the determined discrete power output. The energy storage system includes a power bank management unit to determine an overall power output based, at least in part, on the determined phase of the electric motor; determine a subset of the plurality of cells based, at least in part, on the overall power output; and command each cell of the subset of the plurality of cells to generate the discrete power output, the subset of the plurality of cells to collectively generate an output equal to the overall power output.

### CROSS-REFERENCE TO RELATED APPLICATION

The present application claims priority to U.S. Provisional Patent Application No. 63/115,236, titled SCALABLE MANAGEABLE ENERGY STORAGE-BASED EV POWERTRAIN, filed Nov. 18, 2020, the disclosure of which is hereby incorporated by reference in its entirety.

### FIELD

The present disclosure is generally related to powertrains for electric vehicles and, more particularly, is directed to a powertrain featuring an energy storage system configured to efficiently scale and manage energy generated in accordance to a phase of a motor of an electric vehicle.

### SUMMARY

The following summary is provided to facilitate an understanding of some of the innovative features unique to the aspects disclosed herein and is not intended to be a full description. A full appreciation of the various aspects can be gained by taking the entire specification, claims, and abstract as a whole.

In various aspects, a powertrain for an electric vehicle is disclosed. The powertrain can include an electric motor and an energy storage system electrically coupled to the electric motor. The energy storage system can include a motor control unit configured to determine a phase of the electric motor and a plurality of cells, wherein each of the plurality of cells is configured to determine a discrete power output based, at least in part, on the determined phase of the electric motor and generate the determined discrete power output. The energy storage system can further include a power bank management unit configured to determine an overall power output based, at least in part, on the determined phase of the electric motor; determine a subset of the plurality of cells based, at least in part, on the overall power output; and command each cell of the subset of the plurality of cells to generate the discrete power output, the subset of the plurality of cells is configured to collectively generate an output equal to the overall power output.

In various aspects, an energy storage system configured for use with a powertrain of an electric vehicle is disclosed. The energy storage system can include a motor control unit configured to determine a phase of a motor electrically coupled to the energy storage system and a plurality of cells, wherein each cell of the plurality of cells is configured to determine a discrete power output based, at least in part, on the determined phase of the motor and generate the determined discrete power output. The energy storage system can further include a power bank management unit configured to determine an overall power output based, at least in part, on the determined phase of the motor; determine a subset of the plurality of cells based, at least in part, on the overall power output; and command each cell of the subset of the plurality of cells to generate the discrete power output, the subset of the plurality of cells is configured to collectively generate an output equal to the overall power output.

In various aspects, a method of managing an energy output of a powertrain of an electric vehicle via an energy storage system is disclosed. The powertrain can include a motor electrically coupled to the energy storage system, and the energy storage system can include a motor control unit and a power bank management unit. The plurality of cells can be configured to generate a discrete power output. The method can include: determining, via the motor control unit, a phase of the motor; determining, via motor phase logic, a cell output based, at least in part, on the determined phase of the motor and a cell configuration table; regulating, via a plurality of regulators within the plurality of cells, an output of each cell of the plurality of cells based, at least in part, on the determined cell output; and aggregating, via the power bank management unit, the regulated output of each cell of the plurality of cells, such that the subset collectively generates an output that equals an overall power output corresponding to the determined phase.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a system diagram of a typical powertrain architecture for an electric vehicle, in accordance with one non-limiting aspect of the present disclosure;

FIG. 2 illustrates a system diagram of a scalable, manageable, energy storage-based, powertrain architecture for an electric vehicle, in accordance with at least one non-limiting aspect of the present disclosure;

FIG. 3 illustrates a scalable energy storage system configured for use with the architecture of FIG. 2, in accordance with at least one aspect of the present disclosure;

FIG. 4 illustrates a cell control unit, in accordance with at least one aspect of the present disclosure;

FIG. 5 illustrates another cell control unit, in accordance with at least one aspect of the present disclosure;

FIG. 6 illustrates a block diagram of a cell control unit, in accordance with at least one aspect of the present disclosure;

FIG. 7 illustrates a chart depicting an output response of the powertrain of FIG. 2, in accordance with at least one non-limiting aspect of the present disclosure;

FIG. 8 illustrates a chart depicting an input response of the powertrain of FIG. 2, in accordance with at least one non-limiting aspect of the present disclosure;

FIG. 9 illustrates a cell generating an output as a function of motor phase, as determined by the motor control unit of the powertrain of FIG. 2, in accordance with at least one non-limiting aspect of the present disclosure;

FIG. 10 illustrates a chart depicting a regulated output of the cell of FIG. 9, in accordance with at least one non-limiting aspect of the present disclosure;

FIGS. 11A-C illustrate several schematic diagrams depicting the precision capabilities of the motor control unit generating a motor phase to be used by the cell of FIG. 9, in accordance with at least one non-limiting aspect of the present disclosure;

FIG. 12 illustrates a logic flow diagram of a method of managing the energy output of a powertrain of an electric vehicle, in accordance with at least one non-limiting aspect of the present disclosure; and

FIG. 13 illustrates a block diagram of a scalable energy storage system, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of the present disclosure in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms. Furthermore, it is to be understood that such terms as “forward”, “rearward”, “left”, “right”, “upwardly”, “downwardly”, and the like are words of convenience and are not to be construed as limiting terms.

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

Electric vehicles continue to evolve in terms of design and performance. Although electric vehicles utilize motor-based platforms to reduce the emissions produced by conventional, gas-powered vehicles, electric vehicles have not been mainstream for an extended period of time. Therefore, there are numerous opportunities to improve the performance and efficiency of electric vehicle design. For example, typical powertrains for electric vehicles are complex systems that must be modeled using numerous blocks representing physical systems and/or controllers, because typical powertrains generally decouple the vehicle's energy storage components (e.g., chemical-based battery cells) from its motor controller. It is not uncommon for a model of a typical powertrain for an electric vehicle to include blocks representing: (i) normal/fast charge controllers; (ii) chemical-based energy storage; (iii) BMS; (iv) inverters; (v) transmissions; (vi) brake regeneration; and/or (v) electric motors and motor controllers, depending on the particular implementation. Many of these systems and components require high voltage and current levels (e.g., 600V, 200 A), which increases the price of the typical powertrain for an electric vehicle and potentially renders it a single point-of-failure in the overall system architecture. Furthermore, some of these systems and components require the conversion of direct current (“DC”) to alternating current (“AC”) and vice versa, resulting in a loss of efficiency and increased cost.

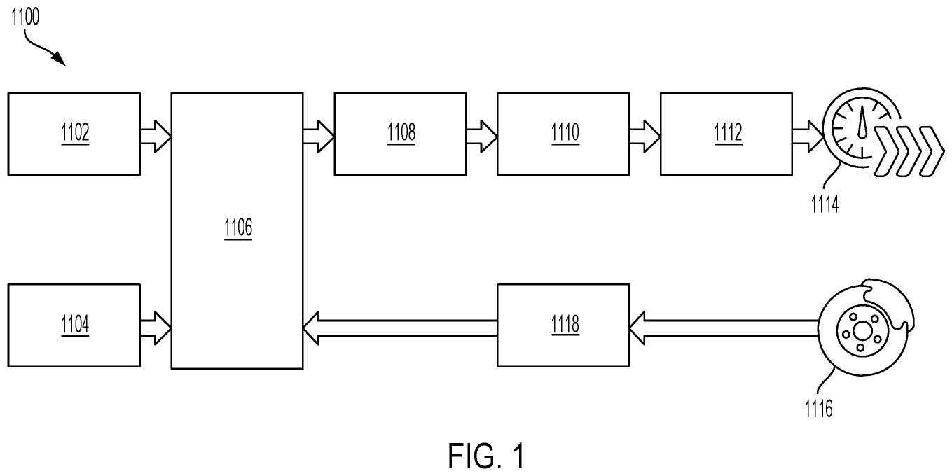

For example, a system diagram of a typical powertrain 1100 architecture for an electric vehicle is depicted in FIG. 1. A typical powertrain architecture 1100 can include numerous blocks (representing numerous subsystems and components) that are coupled to a battery pack 1106. For example, the powertrain 1100 of FIG. 1 includes a charge controller 1102 and a fast charge controller 1104 that feeds into an electric vehicle battery pack 1106, as well as an inverter/motor controller 1108, a motor 1110, a transmission 1112 and other miscellaneous subsystems and components 1114 configured to contribute to the acceleration of the vehicle. Additionally, the typical powertrain 1100 can further include a braking subsystem 1116 and a regeneration controller 1118 coupled to the battery pack 1106 and configured to convert the kinetic energy, as generated through acceleration 1114 of the electric vehicle, into regenerated electricity that is returned to the battery pack 1106 for charging purposes. In this way, typical powertrains 1100 are configured to boost the efficiency of the electric vehicle. In other words, the typical powertrain 1100 for an electric vehicle is coupled to and configured to serve many subsystems and components.

However, typical powertrain architectures, including the powertrain 1100 of FIG. 1, include a significant amount of complexity because each of the coupled subsystems and components 1108, 1110, 1112, 1114, 1116, 1118 implicate high voltage and/or current levels, which ultimately makes it less efficient to control the motor 1110. For example, electric motors, such as the motor 1110 of FIG. 1, require precise timing of current and voltage levels based on the exact rotor position to achieve optimal performance and efficiency. Such precise timing requires instantaneous and coherent change of current and voltage across all phases of the motor. Since typical powertrain 1100 of FIG. 1 implicates high current and/or voltage levels, it inherently requires a longer time to adjust the current and voltage levels in accordance with the precise timing requirements required by the motor 1110 across its multiple phases. Thus, the typical powertrain 1100 result in higher loses, shorter driving ranges, and slower motor responses. Furthermore, typical powertrains 1100 have higher latencies, which can reduce the throttle response, acceleration, and/or braking capabilities of the electric vehicle, itself. Finally, the higher levels of voltage and current required by the typical powertrain 1100 of FIG. 1 results in a non-linear increase in the cost of its various subsystems and components 1102, 1104, 1106, 1108, 1110, 1112, 1114, 1116, 1118, which contributes to the overall cost of the powertrain 1100, itself. Accordingly, there is a need for a scalable, manageable, energy storage-based powertrain for an electric vehicle. Furthermore, having a fixed battery pack 1106 output can limit the efficient operating range of a vehicle, because under some operating conditions (e.g., combinations of RPM and torque, etc.) it can cause increased, unnecessary losses and/or a lack of control.

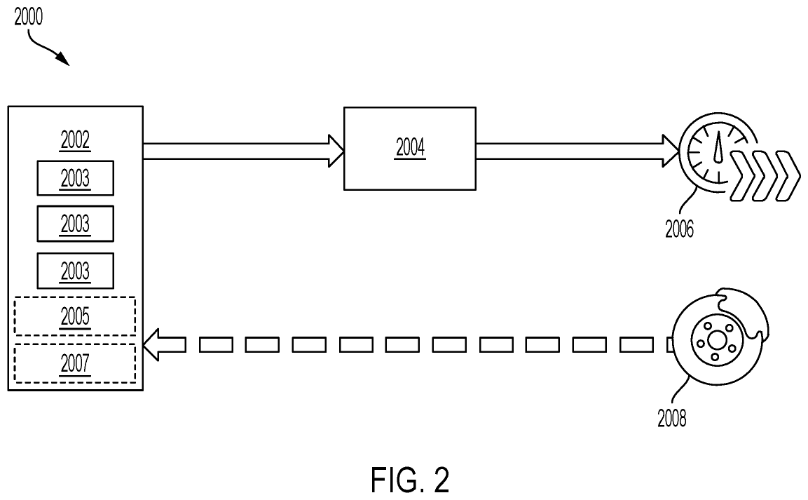

Referring now to FIG. 2, a system diagram of an architecture 2000 for an enhanced powertrain for an electric vehicle is depicted in accordance with at least one non-limiting aspect of the present disclosure. As will be evidence by the present disclosure, the enhanced powertrain 2000 of FIG. 2 can be scalable, manageable, and configured to store energy. According to the non-limiting aspect of FIG. 2, the powertrain 2000 and, more specifically, an energy storage system 2002, is configured to control a motor 2004 directly and thus, can accelerate 2006 the electric vehicle more efficiently without having to provide current and/or voltage to many of the systems and components 1102, 1104, 1108, 1112, 1118 depicted in the typical powertrain 1100 architecture of FIG. 1. In other words, the streamlined powertrain 2000 design of FIG. 2 can provide specific current and voltage outputs for optimal motor 2004 control throughout the many phases of the motor 2004.

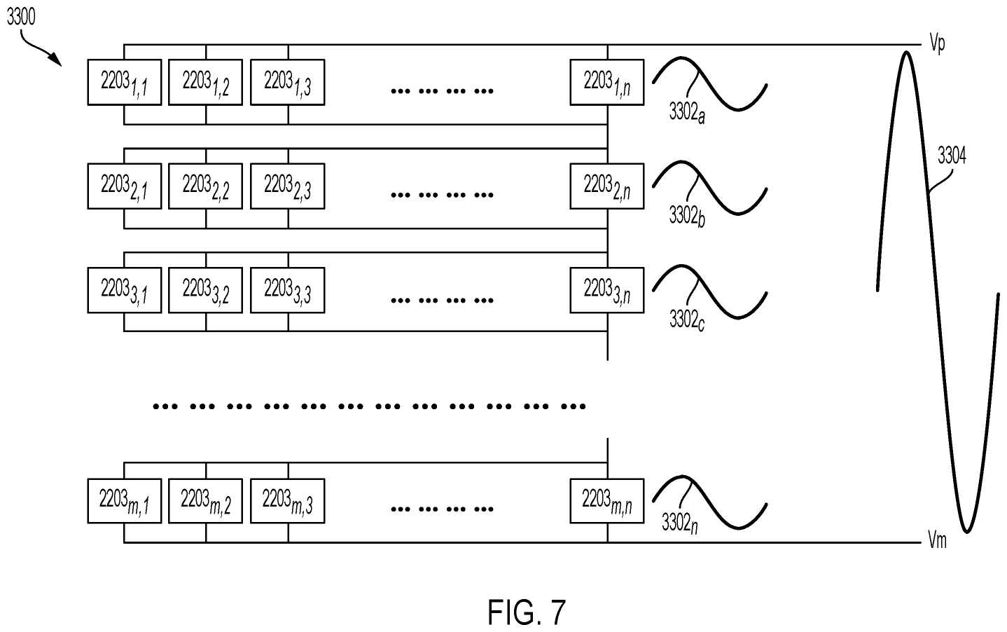

Specifically, the energy storage system 2002 of FIG. 2 can include a plurality of cells 2003, wherein each cell 2003 of the plurality can produce an individual current and voltage output, thereby decentralizing the current and voltage output of the powertrain 2000 of FIG. 2. As such, the powertrain 2000 can employ any number of cells 2003 of the plurality to scale the current and voltage output in accordance with a specific phase of the motor 2004. For example, the powertrain 2000 can utilize any number of cells 2003 of the plurality to produce individual outputs 3302a-n (FIG. 7), which can collectively produce a desired output level 3304, such as the output 3300 depicted in FIG. 7. Of course, any number of cells 2003 can be utilized to produce an number of individual current and voltage outputs 3302a-n (FIG. 7), thereby customizing the collective output 3304 (FIG. 7) of the powertrain 2000, depending on the particular phase of the motor 2004.

Each cell 2003 of the plurality can be individually configured to produce a current and voltage output of approximately 5-10 A and/or approximately 4-10V, respectively. Of course. according to other non-limiting aspects, the aforementioned ranges are examples and the cells 2003 of the energy storage system 2002 of FIG. 2 can be alternately configured to produce a variety of other ranges of amperes and volts. As such, the energy storage system 2002 of FIG. 2 can achieve a very low latency and can precisely control of the overall output of the powertrain 2000 in accordance with a particular phase of the motor 2004, which allows the motor 2004 to operate at an optimal efficiency. Thus, the powertrain 2000 of FIG. 2 provides many advantages over the typical powertrain 1100 of FIG. 1, including a longer range, a faster response time, a lower total cost, and fewer single-point failures. The decentralization offered by the powertrain 2000 of FIG. 2 further reduces complexity, namely, the number of blocks 1102, 1104, 1108, 1112, 1118 required by the typical powertrain 100 architecture of FIG. 1.

According to one non-limiting aspect, the energy storage system 2002 of FIG. 2 can be configured in accordance with the systems disclosed in PCT/US2020/029108, titled SCALABLE AND MANAGEABLE ENERGY STORAGE SYSTEM AND METHOD, filed on Apr. 21, 2020, the disclosure of which is hereby incorporated by reference in its entirety. Specifically, the powertrain 2000 of FIG. 2 can utilize the scalable and manageable energy storage system described in PCT/US2020/029108 as a controller for motor 2004. According to this non-limiting aspect, each cell 2003 of the plurality can be configured as a “smart energy cell,” as described in PCT/US2020/029108. The energy storage system 2002 of FIG. 2 can further include the corresponding cell communication protocol described in PCT/US2020/029108, such that the energy storage system 2002 of FIG. 2 can allow the communication and synchronization between the cells 2003 of the plurality and a power bank management unit 2005. The energy storage system 2002 of FIG. 2 can further include a motor control unit 2007 configured to control motor 2004.

The present disclosure will now summarize relevant disclosure from PCT/US2020/029108 for the purposes of explaining the energy storage system 2002 of FIG. 2. However, the incorporated disclosure from PCT/2020/029108 shall not be limited to the following summary. Specifically, each cell 20003 can include an input regulator and/or an output regulator, and the power bank management unit 2005 of the energy storage system 2002 of FIG. 2 can be configured to communicate a mode of operation to each cell 2003 in the system 2002. For example, an input regulator can be used during a charge cycle of the cells 2003 and an output regulator can be used during a discharge of the cells, as described in PCT/US2020/029108. The cells 2003 can further include one or more switches and the power bank management unit 2005 can further be configured to communicate to the cells 2003 a desired, external energy rail to be selected, as described in PCT/US2020/029108. External energy rails can be connected to a dynamic wiring system (DWS) that allows multiple topologies to be chosen at run time using the switches of the cells 2003. As used herein, “topology” can refer to a configuration of serial/parallel connections of cells 2003 to collect discrete outputs and compile them into an overall current and/or voltage output of the power bank management unit 2005, as described in PCT/US2020/029108. Each cell 2003 can include a cell control unit including an embedded microprocessor unit configured to execute dedicated firmware for operation. The firmware can be configured to optimize and manage use of the regulators and switches within the cells 2003 depending on system mode of operation, storage element state of charge, state of life, factory calibrations, current element temperature or other parameters to maximize storage element life cycle, rate of charge/discharge, and/or safety, amongst other metrics, as described in PCT/US2020/029108. The firmware can manage and/or aggregation energy to and/or from the cells 2003 and can control the DWS, regulators, and/or switches in response to dynamics of an external charge/discharge profile. The communication protocol can coordinate control and/or status messages to be exchanged between power bank management unit 2005 firmware and the cell 2003 control unit firmware, as described in PCT/US2020/029108.

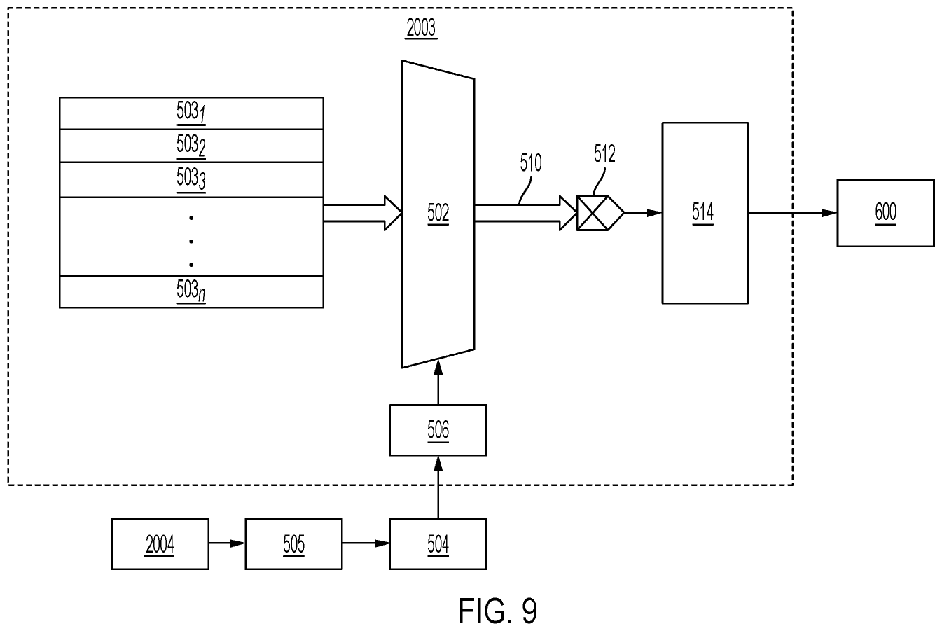

The power bank management unit 2005 can also include a control power source, which can power a control power rail, which can powers the digital logic of each cell control unit, independently from the energy storage system 2002, as described in PCT/US2020/029108. Multiple power banks can be integrated together into a power rack via DWS to support multiple bank wiring topologies and provide wide dynamic range of charge/discharge profiles, as described in PCT/US2020/029108. Power bank management units within a power rack can communicate and coordinate with each other, with the outside world, and/or with an external management unit that can control the power racks, as described in PCT/US2020/029108. The power bank can also include a motor control unit 2007 configured to manage a motor, monitor a rotor position, generate a motor clock, and control the communication protocol with energy cells 2003, which can be coordinated to drive the motor at the desired speed efficiently, respond to dynamic torque changes, brake requests, and start up. Moreover, each cell 2003 and/or a cell control unit can have dedicated hardware and/or firmware to apply the desired voltage and/or current configuration via the input and/or output regulator, as a function of the motor 2004 mode of operation and/or a rotor 504 (FIG. 9) position. The output regulator of each cell 2003 can be capable of driving an exact voltage and/or current level on cell's 2003 output as a function of the rotor 504 (FIG. 9).

The output regulator of each cell 2003 of FIG. 2 can deliver an arbitrary output voltage and/or current to the motor 2004, independent of the state of the cell or cells 2003 it is controlling at a given time. Moreover, via the cell communication protocol, the power bank management unit 2005 can enable system-wide synchronization, such that the output voltage and/or current waveforms can be coherently generated by the cells 2003. As such, the local output of each cell 2003 can add up to the total output of the energy storage system 2002 of the powertrain 2000 of FIG. 2. The output of the energy storage system 2002, therefore, can be controlled with a low latency, since it is a sum of the discrete outputs of a required number of cells 2003 of the plurality. For example, according to some non-limiting aspects, the cells 2003 can employ a DC/DC converter as the output regulator. The DC/DC converter can combine discrete outputs from one or more cells 2003, which may include a low voltage and/or current, and generate a high-switching frequency, that contributes to the low latency of the overall output of the energy storage system 2002 while enabling a fast, transient response. However, according to other non-limiting aspects, the cells 2003 can include other output regulators, such as a buck converter, a boost converter, a buck-boost converter, a DC/AC converter, an AC/AC converter, a current source, and/or a low dropout regulator to deliver energy to or from the energy storage system 2002, amongst others.

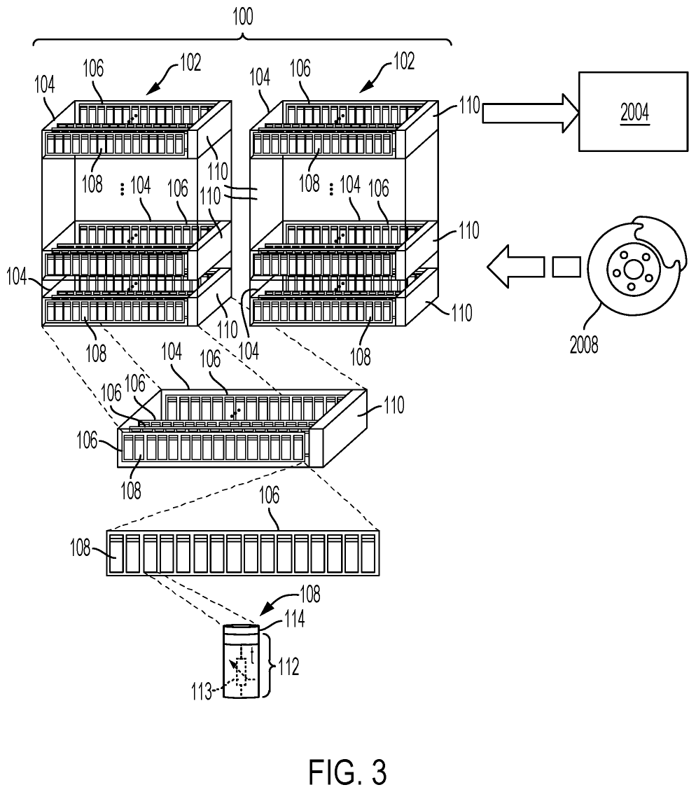

Referring now to FIG. 3, a scalable energy storage system 100 configured for use with the architecture 2000 of FIG. 2 is depicted in accordance with at least one aspect of the present disclosure. The scalable energy storage system 100 includes one or more than one power rack 102 that integrates one or more than one power bank 104. A power bank 104 may include one or more than one groups 106 of energy cells 108 and a power bank management unit 110. Each energy cell 108 in the group 106 may include an energy storage element 112. In some aspects, the power banks 104 are configured to communicate externally and coordinate to provide a larger scalable energy storage system (SESS).

The power bank 104 comprises a control power source to provide digital control power to all control power rails described herein as well as to the power bank management unit 110, thus providing independence of the control logic from the state of the energy storage elements 112. The power banks 104 can be connected together using a rack dynamic wiring system that connects bank energy rails into rack energy rails using dynamic configurations. The power bank management unit 110 of each power bank 104 within the rack 102 can communicate with each other as well as with external world.

In one aspect, the power bank management unit 110 comprises digital logic and analog circuits and provides communication with cell control units described herein to manage and coordinate the operation of the energy cells 108, groups 106 of energy cells 108, and power bank 104 operations including the implementation of a dynamic wiring system described herein. The digital portion of the power bank management unit 110 comprises one or more than one processor configured to execute embedded management firmware, memory, nonvolatile storage storing pertinent data and processor instructions, programmable logic, field programmable gate array (FPGA), discrete digital logic circuits, or combinations thereof. The management firmware also implements a cell communication protocol described herein as well as external power bank 104 communication and coordinates the operations of the cell control units to achieve the desired voltage and current on the bank energy rail. The power bank management unit 110 firmware also maintains current and historical states of the power bank 104 and its energy storage elements 112.

In one aspect, the building block of the scalable energy storage system 100 is an energy storage element 112. The energy storage element 112 may be a form of electric battery cell that can hold energy at certain densities and be charged and discharged multiple times. Each electric energy storage cell 112 can be built using any existing or future technology like Lithium-based, Nickel-based, supercapacitor, lead-acid, or any other existing or future rechargeable battery technology. Each energy storage element 112 has unique characteristics and performance metrics such as rate of charge/discharge, maximum current/voltage it is capable of supporting safely, temperature dependency, life cycle or percentage of degradation of capacity as a function of number of charge/discharge cycles the energy storage element 112 went through during its usage, state of charge or the amount of energy left in an energy storage element 112, which is also a function of life cycle, current rate of charge/discharge, temperature, or other elements.

The scalable and manageable energy storage system 100 described herein allows the aggregation of a large number of energy storage elements 112 while taking into account the unique characteristics of each energy storage element 112, allowing the scalable and manageable energy storage system 100 to achieve the most optimized charge/discharge rate, maximum current/voltage, state of charge defined as the amount of energy stored by the element 112, state of life defined as the maximum usable power storage at present moment, life cycle, safety, and other performance metrics.

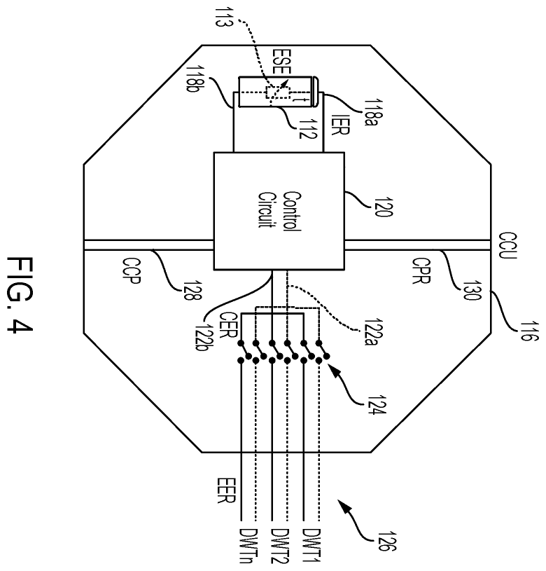

Each energy cell 108 comprises an energy storage element 112 controlled by an element management unit 114 comprising unique digital and/or analog control circuits. The combination of the energy storage element 112 and the element management unit 114 forms a single managed cell control unit 116 as described below in connection with FIG. 4. In one aspect, a temperature sensor 113 may be located as close as possible to the energy storage element 112 or formed integrally with the energy storage element 112. The temperature sensor 113 provides the temperature T of the energy storage element to the element management unit 114, for example.

FIG. 4 illustrates a cell control unit 116 configured to independently control and manage one energy storage element 112, in accordance with at least one aspect of the present disclosure. In one aspect, the scalable and manageable energy storage system 100 may comprise an array of cell control units 116, each of which independently controls and manages one or more than one energy storage element 112. This may be done by optimizing and controlling the voltage and current of the energy storage elements 112 individually, independently from the external voltage/current variations. The energy storage element 112 may comprise a temperature sensor to measure the temperature of the energy storage element 112.

The energy storage element 112 comprises an internal energy rail 118a, 118b to connect the positive and negative terminals of the energy storage element 112 to the control circuit 120, which may comprise a general purpose processor or digital logic circuit that executes dedicated cell control firmware. One function of the cell control unit 116 (CCU) is to isolate the internal energy rail 118a, 118b (IER) of the energy storage element 112 (ESE) from the rest of the energy storage system 100, with the purpose of optimizing charge/discharge operations to extending energy storage element 112 life cycle, rate of charge/discharge, manage dynamic load/charge profiles, etc. In the illustrated example, one energy rail 118a is the positive energy rail and the other energy rail 118b is the negative energy rail. In one aspect, the temperature sensor 113 is located as close as possible to the energy storage element 112 or formed integrally with the energy storage element 112 to provide the temperature t of the energy storage element 112 to the control circuit 120.

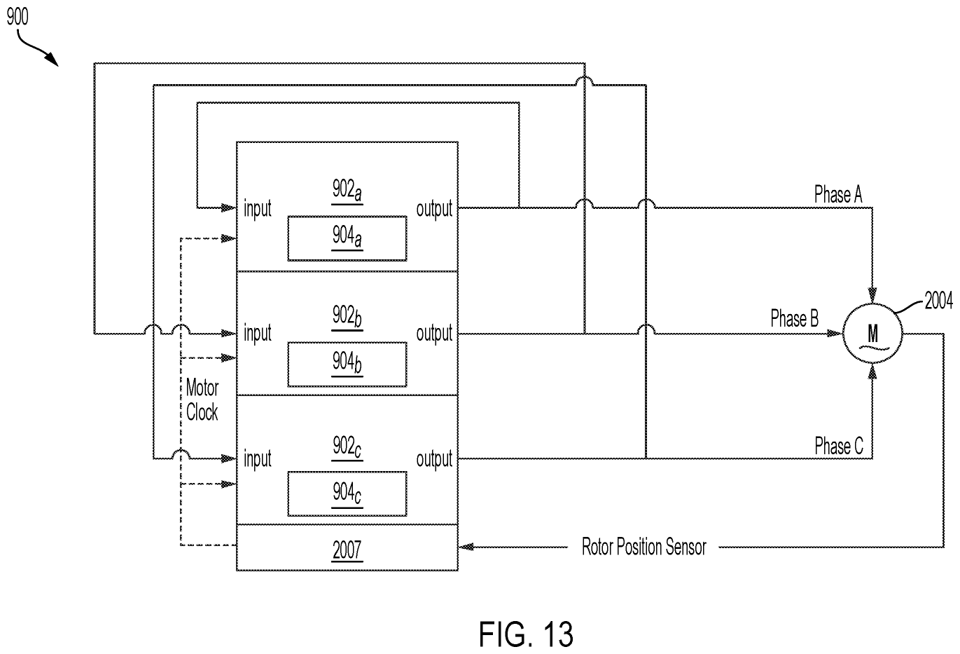

The control circuit 120 comprises a digital control circuit comprising a processor or multiple processors executing embedded firmware, memory, nonvolatile storage to store pertinent data and processor instructions, digital logic circuits, and analog circuits. In one aspect, the control circuit 120 comprises a processor and memory configuration as described in connection with FIGS. 13 and 14 to execute firmware and manage the cell control unit 116. The digital control circuit functions include control the voltage regulators, switches, temperature sensor, voltage and current measurements circuits, implement the cell communication protocol 128 to manage the state of charge and state of life of the energy storage element 112. The control circuit 120 comprises digital and/or analog circuits coupled between the internal energy rails 118a, 118b and cell energy rails 122a, 122b (CER). In the illustrated example, one output energy rail 122a is the positive output energy rail and the other energy rail 122b is the negative energy rail. Accordingly, the cell control unit 116 can perform both digital and analog functions to manage one or more than one energy storage element 112 state of charge and state of life.

With reference now also to FIG. 3, the cell communication protocol 128 provides the mechanism for each individual cell control unit 116 to communicate with the power bank management unit 110. The cell communication protocol 128 also provides a way for the power bank management unit 110 to discover the location and neighbors of a cell control unit 110 within its group 106. Multicast, broadcast, and unicast messages can be exchanged between the power bank management unit 110 and the cell control units 116 using the cell communication protocol 128. It also provides a way of time-synchronization of the energy cells 108 within the power bank 104 with the power bank control unit 110.

Back to FIG. 4, the control circuit 120 comprises firmware modules and algorithms to control the regulators and energy rail switches 124 to manage the state of charge and state of life of the energy storage element(s) 112 during a charge cycle and the voltage/current of the cell energy rail 122a, 122b during a discharge cycle. The algorithms also can be tailored to various battery technologies.

The control circuit 120 optimizes charge/discharge operations and extends the life cycle, rate of charge/discharge, manages dynamic load/charge profiles, of the energy storage element 112 by using run-time adjustable regulators such as buck, boost, buck/boost DC/DC converters, DC/AC converters, AC/AC converters, current source, low dropout (LDO) regulator, etc. The control circuit 120 is separately powered through a control power rail 130 (CPR) supplied by the control power source in the power bank 104. Providing a separate power source for the control circuit 120 provides independent functionality of the energy cell 108 (FIG. 1) regardless of the state of charge of the energy storage elements 112 at all times.

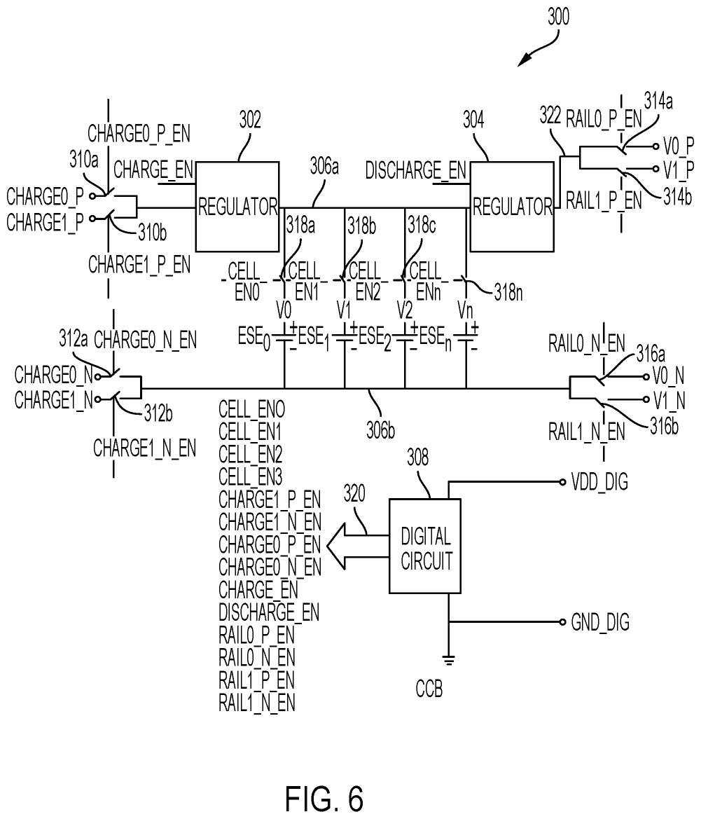

As described in more detail with reference to FIG. 6, the control circuit 120 may comprise an input regulator and an output regulator. In one aspect, the cell energy rail 122a, 112b to internal energy rail 118a, 118b voltage and current regulators are programmable high efficiency power regulators that regulate the voltage and current on the external energy rails 122a, 122b to the internal energy rail 118a, 118b. The regulators control the voltage and current seen by each of the energy storage elements 112 under their control. Internal energy rail 118a, 118b to cell energy rail 122a, 122b voltage and current regulators are programmable high efficiency power regulator that regulate the voltage and current on the internal energy rails 118a, 118b to the cell energy rail 122a, 122b. The control circuit 120 comprises voltage and current measurement circuits to measure the current and voltage on the internal energy rail 118a 118b, the cell energy rail 122a, 122b, and the external energy rails 126, for example.

The input regulator is employed during a charge cycle of the energy storage element 112 and the output regulator is employed during a discharge cycle of the energy storage element 112. As described above, the input/output regulators isolate the internal energy rails 118a, 118b of the energy storage element 112 from the rest of the energy storage system 100. During a charge cycle, the input regulator optimizes the voltage/current at the internal energy rail 118a, 118b of the energy storage element 112. During a discharge cycle, the output regulator generates the desired voltage/current at the output energy rail 122a, 122b. The control circuit 120 also may employ electronic programmable power rail switches to connect/disconnect the internal energy rail 118a, 118b from the input regulator and to disconnect/connect the internal energy rail 118a, 118b from the output regulator. In one aspect, the input and output regulators can be implemented as a single regulator and may be the same regulator.

In one aspect, the cell control unit 116 also may comprise additional electronic energy rail switches 124 for connecting/disconnecting the output cell energy rail 122a, 112b to the external energy rails 126 (EER). In one aspect, the external energy rails 126 may be connected to a dynamic wiring system that allows the energy storage element 112 to be connected to one of a plurality of dynamic wiring topologies (DWT1, DWT2, . . . DWTn) supported in the power bank 104 (FIG. 3) through the output energy rail 122a, 122b to be chosen at run time using the energy rail switches 124 at the energy storage element 112 level. Topology refers to configuration of serial/parallel connections of energy storage elements 112 to change the overall current/voltage of the power bank 104. The energy rail switches 124 are programmable power switches that can connect or disconnect the cell energy rail 122a, 122b to/from the group or external energy rails 126, and/or connect/disconnect the internal energy rail 118a, 118b from the input/output regulators such as, for example, regulator 302 and regulator 304 shown in FIG. 6. Switching from the dynamic wiring topology requires time-synchronization between all cell control unit 116 that can be achieved via the cell communication protocol 128 and uses the energy rail switches 124 under control of the firmware executed by the control circuit 120 or digital circuit 308.

Using the dynamic wiring system combined with the aforementioned regulators and energy rail switches 124 allows real time coarse and fine configurations that can enable the energy storage system 100 to respond to a large dynamic range of charge/discharge profiles in real time with very low latency. Coarse changes may be accomplished by switching to different wiring topology using the dynamic wiring system and fine control accomplished by using regulators.

Since the current/voltage control is performed at the energy storage element 112 level, the regulators and energy rail switches 124 used to accomplish this functionality need to be rated for relatively low current and voltage and lower latency, which makes it more efficient and cost effective than the alternative of regulating the voltage and current on the output of the group/bank as it is currently implemented in existing energy storage systems. For example, a CMOS-based electronic switch is orders of magnitude more reliable and cost-effective when it is designed for 5V/10 A versus 100V/200 A. 18. Accordingly, the energy rail switches 124 that switch the external energy rails 126 to achieve a dynamic wiring system do not need to be rated for the typical high electrical current that a group energy rail expects since the external energy rails 126 sees only the electrical current of a single energy storage element 112.

In one aspect, each energy storage element 112 is managed by dedicated firmware executed by the control circuit 120 that optimizes and manages the regulators and the energy rail switches 124 depending on system mode of operation, energy storage element 112 state of charge, energy storage element 112 state of life, or other parameters to maximize storage element life cycle, rate of charge/discharge, safety, or other desired metrics.

In one aspect, the power bank 104 (FIG. 3) also may have dedicated firmware that manages the aggregation of energy to/from the energy storage elements 112, and can coordinate dynamic wiring system and the energy storage element regulators/switches in response to the dynamics of external charge/discharge profiles. These functions may be implemented in the power bank management unit 110 (FIG. 3).

In one aspect, coordination between the power bank management unit 110 (FIG. 3) firmware and the cell control unit 116 firmware may be achieved using a cell communication protocol rails 128 (CCP) that allows control and status message exchange using broadcast/multicast/unicast messages. To prevent or minimize the energy storage system-level voltage/current transients each active energy storage element 112 starts/stops powering the external energy rails 126 at the same time. Accordingly, in one aspect the cell communication protocol 128 provides a time-synchronization mechanism across the system to provide coherency.

With reference now to FIGS. 3 and 4. each power rack 102 comprises one or more power banks 104 interconnected by rack energy rails and communicate with each other over a power bank 104 communication protocol. Each power bank 104 also comprises a control power source, a power bank management unit 110, groups 106 of energy cells 108 comprising cell control units 116 that communicate with each other over a cell communication protocol 128. Each cell control unit 116 is coupled to the power bank 104 through external energy rails 126, the control power rail 130 to power the control circuit 120, and a dynamic wiring system. Groups 106 of energy cells 108, each comprising a cell control unit 116, may be dynamically connected in parallel, series, combinations of parallel and series, in phase relation, or combinations thereof. Bank energy rails connect to group energy rails using a dynamic wiring system. The bank energy rails carry the electric energy coming in and out of the power bank 104.

The cell control units 116 communicate over the cell communication protocol 128 and may be dynamically coupled to the group external energy rails 126 or the control power rail 130 during run-time. Each cell control unit 116 comprises one or more than one energy storage element 112, an element management unit 114, an internal energy rail 118a, 118b, a cell energy rail 122a, 122b, a control power rail 130, and a cell communication protocol 128. Each cell control unit 116 comprises a digital/analog control block shown as a control circuit 120 comprising digital and analog circuits for regulating charging/discharging functions, measuring energy storage element 112 temperature, voltage and current of internal and external energy rails 122a, 122b. 126, internal to external energy rails voltage and current regulators, external to internal energy rail voltage and current regulators, and one or more energy rail switches 124.

A group of cell control units 116 share the same group energy rails and may be connected in parallel to all the external energy rails 216 from each energy cell 108. The number of group energy rails matches the number of external energy rails 126 for each cell control unit 116.

In some aspects, one or more than one dynamic wiring topology can be selected for state of charge balancing of the energy cells 108 across the energy storage system 100. This dedicated balancing wiring topology connects to both external charge and discharge energy rails of each energy cell 108. This allows the power bank management unit 110 to redistribute the energy by providing a command, for example, to energy cells 108 with a higher state of charge to connect to the discharge energy rail of the balancing wiring topology and energy cells 108 with a lower state of charge to connect to the charge energy rail of this topology. This will achieve a healthier overall state of charge for the energy storage elements 112 throughout the energy storage system 100. In some aspects, the dynamic wiring system can be used to switch phases between negative and positive terminals, when the positive of one external energy rail connects to negative terminal of the other and vice versa, this could allow the regulator to generate/receive negative external voltage in respect of its own voltage. In other aspects, each energy cell 108 can have access to external (shared) resistor to enable full discharge in case of energy storage element 112 state of charge recalibration.

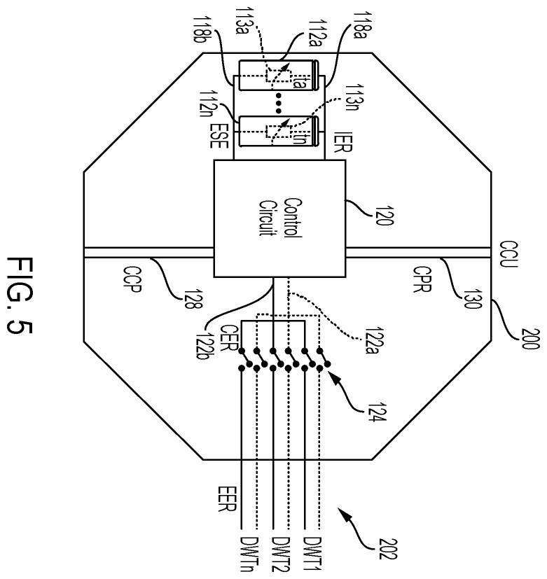

FIG. 5 illustrates a cell control unit 200 configured to independently control and manage two or more energy storage elements 112a, 112n, in accordance with at least one aspect of the present disclosure. Functionally, the cell control unit 200 is similar to the cell control unit 116 described in FIG. 4. As previously described, in one aspect, the control circuit comprises a processor and memory configuration to execute firmware and manage the cell control unit 200. In one aspect, each of the energy storage elements 112a/n may comprise a temperature sensor 113a/n located as close as possible to the energy storage element 112a/n or formed integrally with the energy storage element 112a/n to provide the temperature “ta/tn” of the energy storage element 112a/n to the control circuit 120.

FIG. 6 is a block diagram of a cell control unit 300, in accordance with at least one aspect of the present disclosure. The cell control unit 300 comprises an input charge regulator 302 and an output discharge regulator 304. The input regulator 302 is used during the charge cycle and the output regulator 304 is used during the discharge cycle. In other aspects, the input regulator 302 may comprise a plurality of regulators and the output regulator 304 may comprise a plurality of regulator. In yet other aspects, the charge and discharge functions may be implemented by a single regulator. The input and output regulators 302, 304 are run-time adjustable and may be implemented as buck, boost, buck/boost DC/DC converters, DC/AC converters, AC/AC converters, current sources, low dropout regulators, among other types of regulators.

A plurality of energy storage elements ESE0, ESE1, ESE2, . . . ESEn are coupled between the input and output regulators 302, 304. The positive ends of the energy storage elements ESE0-ESEn are coupled to a positive internal energy rail 306a and the negative ends of the energy storage elements ESEO-ESEn are coupled to the negative internal energy rail 306b. The positive internal energy rail 306a is coupled each of the energy storage elements ESEO-ESEn through corresponding switches 318a, 318b, 318c, . . . 318n.

A first set of input switches 310a, 31 Ob couple the positive charging rails CHARGE_0_P/CHARGE_1_P of the charging source to the input regulator 302 and a first set of energy rail switches 314a, 314b couple the cell energy rail 322 output of the output regulator 304 to the positive external energy rails V0_P/V1_P, which may be coupled to a load or to other cell control units, for example. A second set of input switches 312a, 312b couple the negative internal energy rail 306b to the negative charging rails CHARGE_0_N/CHARGE_1_N of the charging source. A second set of energy rail switches 316a, 316b couple the negative internal energy rail 306b to the negative external energy rails V0_NN1_N, which may be coupled to the load or to other cell control units, for example.

A digital control circuit 308 is separately powered through a control power rail VDD_DIG, GND_DIG. As previously described, in one aspect, the control circuit 308 comprises a processor and memory configuration as described in connection with FIGS. 13 and 14 to execute firmware and manage the cell control unit 300. Various output lines 320 of the digital control circuit 308 are coupled to the enable inputs CHARGE_EN/DISCHARGE_EN of the input and output regulators 302, 304 to enable and disable the charging and discharging functions of the regulators 320, 304. Other output lines 320 of the digital control circuit 308 are coupled to the enable inputs CHARGE_0_P_EN/CHARGE_1_P_EN of the first set of input switches 310a, 310b and the enable inputs CHARGE_0_N_EN/CHARGE_1_N_EN of the second set of input switches 312a, 312b to control the ON/OFF state of the switches 310a, 310b, 312a, 312b to connect/disconnect the charging source coupled to the positive and negative charging rails CHARGE_0_P/CHARGE_1_P and CHARGE_0_N/CHARGE_1_N to the input charge regulator 302. Other output lines 320 of the digital control circuit 308 are coupled to the enable inputs RAIL_0_P_EN/RAIL_1_P_EN of the first set of energy rail switches 314a, 314b and the enable inputs RAIL_0_N_EN/RAIL_1_N_EN of the second set of energy rail switches 316a, 316b to control the ON/OFF state of the energy rail switches 314a, 314b, 316a, 316b to connect I disconnect the cell energy rail 322 of the output discharge regulator 304 to the positive external energy rails V0_P/V1_P. Other output lines 320 of the digital control circuit 308 are coupled to the enable inputs CELL_EN0, CLL_EN1, CELL_EN2, . . . CELL_ENn of the energy storage elements ESEO, ESE1, ESE2, . . . ESEn to control the charging and discharging cycles of the energy storage elements ESEO, ESE1, ESE2, . . . ESEn in a coordinated synchronized process as described hereinbelow. In one aspect, the cell control unit 300 also includes measurement circuits to monitor voltage/current on each of the energy storage elements ESEO, ESE1, ESE2, . . . ESEn and the cell energy rails 322. The voltage of each energy storage elements ESEO-ESEn is indicated as V₀, V₁, V₂, . . . Vn.

During the charge cycle, the cell control unit 300 monitors currents/voltages on each of the energy storage elements ESEO, ESE1, ESE2, . . . ESEn and the cell energy rails 306a. The cell control unit 300 also could monitor the temperature of each of the energy storage elements ESEO, ESE1, ESE2, . . . ESEn, and adjusts the input regulator(s) 302 based on these measurements and energy storage elements ESEO, ESE1, ESE2, . . . ESEn calibration information, state of charge, state of life, external charging supply dynamics, and other parameters to control the rate of charge into the energy storage elements ESEO, ESE1, ESE2, . . . ESEn.

During the discharge cycle, the cell control unit 300 adjust the output regulator(s) 304 based on the system level requirements, current and voltages at different rails, energy storage element ESEO, ESE1, ESE2, . . . ESEn temperature, state of charge, state of life, factory calibration and other parameters to extend the life of each of the energy storage elements ESEO, ESE1, ESE2, . . . ESEn, guarantee safety and provide a response to dynamic load conditions or output the desired real-time voltage/current.

In a standby state, the cell control unit 300 isolates the energy storage elements ESEO, ESE1, ESE2, . . . ESEn by disconnecting the energy rail switches 314a, 314b, 316a. 316b from the external energy rails V0_P. V1_P, V0_N, V1_N and disabling the input and output regulator(s) 302, 304. The standby state allows to minimize leakage, while maintaining fast response ability to move to charging/discharging states.

Also, in one aspect, the cell control unit 300 may be set in a low power storage mode (deep sleep) by disconnecting all the energy rail switches 314a/b, 316a/b, 318a/b/c/n from the external energy rails V0_P, V1_P, V0_N, V1_N, disabling the input and output regulator(s) 302, 304, and powering down most of the digital logic circuits of the digital circuit 308. This eliminates most leakage and require a longer time to move to standby mode.

The control functions within the cell control unit 300 may be implemented in the digital circuit 308 logic that may include a general purpose processor that executes dedicated cell control firmware. In some aspects, the digital circuit 308 may comprise more than one processor or no processor and use digital logic instead, such as field programmable gate arrays (FPGA), programmable logic devices (PLD), discrete logic, or analog circuits, or combinations thereof.

The firmware/digital logic runs a program (e.g., executes a set of machine executable instructions) to optimize charge/discharge operations by collecting internal and external voltage, current, and temperature of each of the energy storage elements ESEO, ESE1, ESE2, . . . ESEn and uses these measurements in conjunction with stored energy storage element-specific calibration data to control the input/output regulators 302, 304. The firmware/digital logic also communicates with the power bank management unit 110 (FIG. 3) to coordinate bank-wide operations. For example, when the power bank management unit 110 during a discharge cycle wants to adjust the total external voltage of the bank, the power bank management unit 110 can issue a command to all the energy storage elements ESE0, ESE1, ESE2, . . . ESEn, energy cells 108, or cell control unit 300 to adjust the input/output regulators 302, 304 accordingly.

With reference now to FIGS. 3-6, in some aspects, the energy cells 108 include an energy storage element 112 controlled by an element management unit 114 (FIG. 3) together forming a single managed cell control unit 116 (FIG. 4), the cell control unit 200 (FIG. 5), and the cell control unit 300 (FIG. 6) may be integrated into groups 106. All the energy cells 108 in the group 106 may be connected in parallel to allow redundancy and avoid a single point of failure, e.g., the corresponding cell external energy rails 126 (202, V0_P, V1_P) for each energy cell 108 are connected. The group 106 may contain a number of energy cells 108, which may vary depending on mechanical/electrical/system design constraints of a particular implementation.

With reference now to FIGS. 3-6, the cell communication protocol is a message exchange mechanism between the power bank management unit 110 (Master) and cell control units 116, 200, 300 (Slaves). It allows the power bank management unit 110 to send a broadcast message to all the energy cells 108 within the power bank 110 or unicast message to an individual energy cell 108.

Referring now to FIG. 7, an example output response 3300 of a power bank of the energy storage system 2002 of FIG. 2 is depicted in accordance with at least one non-limiting aspect of the present disclosure. Specifically, the energy storage system 2002 of FIG. 2 can cause each cell 2003 to regulate each individual cell 2003 output, such that an overall output 3304 is generated that can be provided to the motor 2004 (FIG. 2) or any other systems and/or components electrically coupled downstream the energy storage system 2002 (FIG. 2). According to the non-limiting aspect of FIG. 7, the plurality of cells 2003 can be configured in a matrix 2003_{m,n}. For example, one or more cells 2003_{1,1}, 2003_{1,2}, 2003_{1,3} . . . 2003_{1,n} can be configured to generate a discrete voltage and/or current 3302ₐ, which, in collectively with other discrete responses 3302_{b}, 3302₄ . . . 3302ₙ constitute the overall response 3304, which provides a low latency, fast, and transient voltage and/or current that can be provided to the motor 2004 (FIG. 2) at a particular phase.

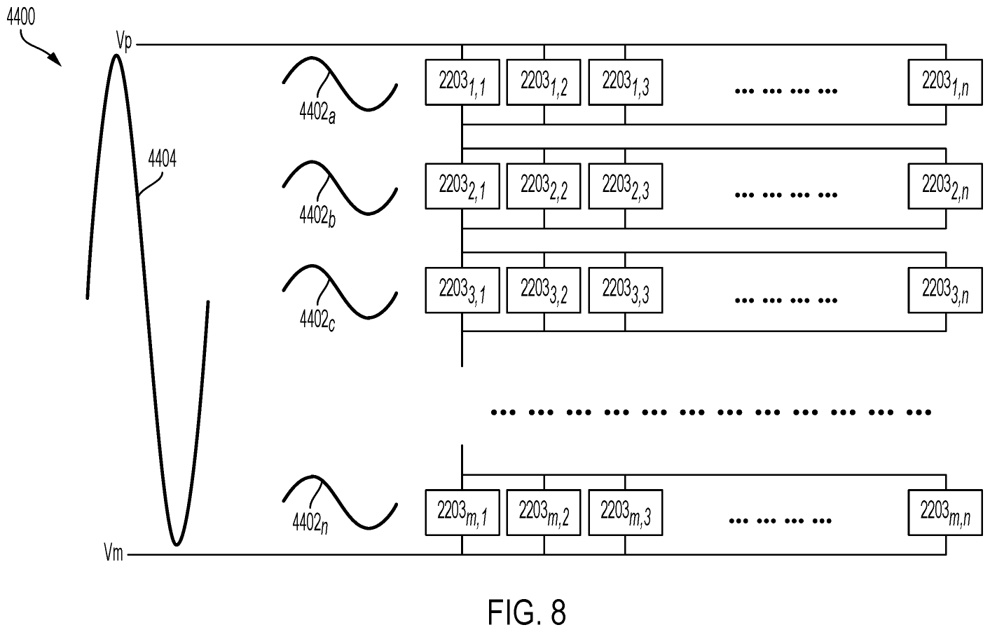

Referring now to FIG. 8, an example input response 4400 of a cell 2003 of FIG. 2 is depicted in accordance with at least one non-limiting aspect of the present disclosure. Specifically, when the power bank management unit 2005 (FIG. 2) of the energy storage system 2002 of FIG. 2 is configuring the cells 2003 to regulate input, it can process an overall input 4404 provided by the regenerative braking system 2008 (FIG. 2) or any other systems and/or components electrically coupled upstream the energy storage system 2002 (FIG. 2). Once again, according to the non-limiting aspect of FIG. 8, the plurality of cells 2003 can be configured in a matrix 2003_{m,n}. However, when the power bank management unit 2005 (FIG. 2) of the energy storage system 2002 of FIG. 2 is configuring the cells 2003_{m,n} to regulate input, the overall input 4404 can be processed into discrete voltages and/or currents 4402ₐ, 4402_{b}, 4402_{c} . . . 4402ₙ, which can be distributed across one or more cells 2003_{1,1}, 2003_{1,2}, 2003_{1,3} . . . 2003_{1,n} of the matrix 2003_{m,n}.

In further reference to FIG. 8, input regulators of the cells 2003 can cause the energy storage system 2002 of FIG. 2 to sink an arbitrary input voltage and/or current from the regenerative braking system 2008 (FIG. 2), independent of the state of the cell or cells 2003 being controlled at a given time. Due to the system-wide synchronization enabled by the power bank management unit 2005 (FIG. 2)—and more specifically, the cell communication protocol—the energy storage system 2002 can coherently sink the arbitrary input voltage and/or current via one or more cells 2003 of the plurality. As a result, the total input level provided to the energy storage system 2002 can be sub-divided into smaller input levels applied by the power bank management unit 2005 to one or more cells 2003 of the plurality. However, according to other non-limiting aspects, the cells 2003 can include other input regulators, such as a buck converter, a boost converter, a buck-boost converter, a DC/AC converter, an AC/AC converter, a current source, and/or a low dropout regulator to deliver energy to or from the energy storage system 2002, amongst others.

Output regulators of each cell 2003 (FIG. 2) can be used to drive each phase of the motor 2004 (FIG. 2) efficiently, in a timely manner, and as a function of an exact rotor position of the motor 2004 (FIG. 2). In order to determine the exact rotor position, the system 2002 (FIG. 2) can further include a rotor monitoring system 505 communicably coupled to the motor control unit 2007. For example, the rotor monitoring system 504 can include a sensor (e.g., optical, hall, etc.), a decoder, and/or an electromotive force measurement device, amongst other devices configured to estimate a position of the rotor at a particular time. The estimated rotor's position can be communicated to each cell 2003 (FIG. 2) in real time. As shown in FIG. 9, a motor clock can be generated from a dedicated control block, such as the motor control unit 2007 (FIG. 2), via inputs from a monitoring system 505 and/or other techniques, such as an interpolation algorithm that can be used to produce improved rotor position estimates beyond what may be achieved via sensory inputs alone. For example, the interpolation algorithm can use metrics (e.g., using speed, acceleration, motor inertia, external load hysteresis, etc.) associated with the rotor to determine its precise position.

Each cell 2003 (FIG. 2) and/or cell control unit can use the motor clock to dynamically generate an optimal output voltage and/or current that corresponds to the communicated rotor position, as shown on FIG. 9. For example, in some aspects each cell 2003 (FIG. 2) can receive the desired voltage and/or current output corresponding to each position of the rotor as well as a scaling factor 512 that scales the cell output up or down, as a function of a desired motor speed and/or torque. As the rotor proceeds through its revolution, the voltage and/or current configuration 503_{1,n} corresponding to the rotor's phase is selected and can be selected and output via the cell 2003 output regulator. This can result in each cell 2003 (FIG. 2) outputting coherent waveforms that will be added up to generate the desired waveform at the system's 2000 (FIG. 2) output.

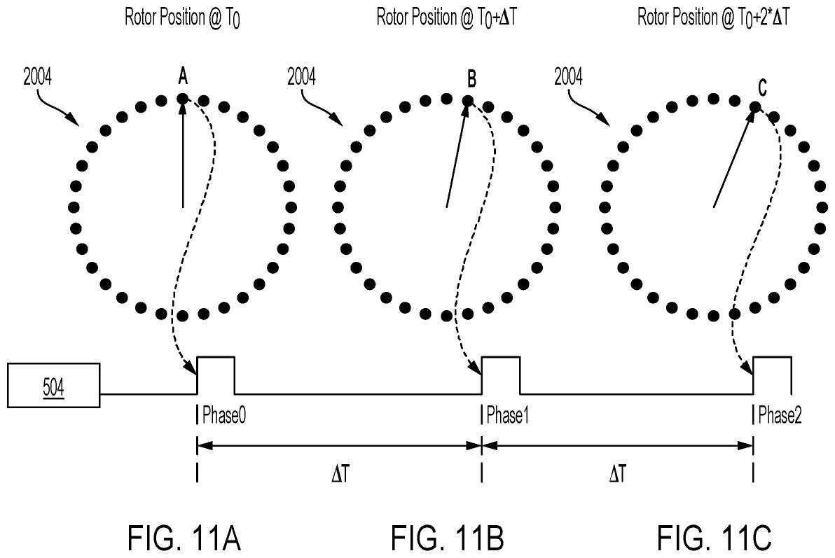

In further reference to FIG. 9, each cell 2003 and, more specifically, each cell control unit, can precisely determine the position of the rotor and thus, the phase of the motor 2004 by tracking the smallest angular movement of the rotor via the rotor monitoring system 505. According to some non-limiting aspects, the rotor monitoring system 505 can be positioned within the motor control unit 2007, which can operate with a precision that will be further discussed in reference to FIGS. 11A-C. The rotor monitoring system 505, that generates a motor clock 504 based on motor position and the desired motor speed and/or torque, provides inputs to motor phase logic 506 within the cell 2003, which can provide an input signal to a multiplexer 502. Based on the detected phase of the motor 2004, as sensed by the monitoring system 505 and determined by the motor phase logic 506, the cell 2003 can be configured to determine a overall current and/or voltage requirement 510 output, and scale 512 the output of the multiplexer 502, as necessary. The scaler 512 can scale the magnitude of the output of the cell 2003. According to some non-limiting aspects, the scaler 512 output can be determined by the communication protocol and applied synchronously across the system 2000, for example, at a predetermined rotor position, as detected and determined by the monitoring system 505 and motor clock 504. Thus, the regulator 514 of the cell 2003 can ensure that the cell 2003 produces the discrete electrical response, or configuration 503₁₋ₙ, as required for the determined phase. As such, the cell of FIG. 9 can continuously produce regulated responses or electrical configuration 503₁₋ₙ that correspond to the each particular phase of the motor 2004, resulting in a cell output 600 that varies by phase.

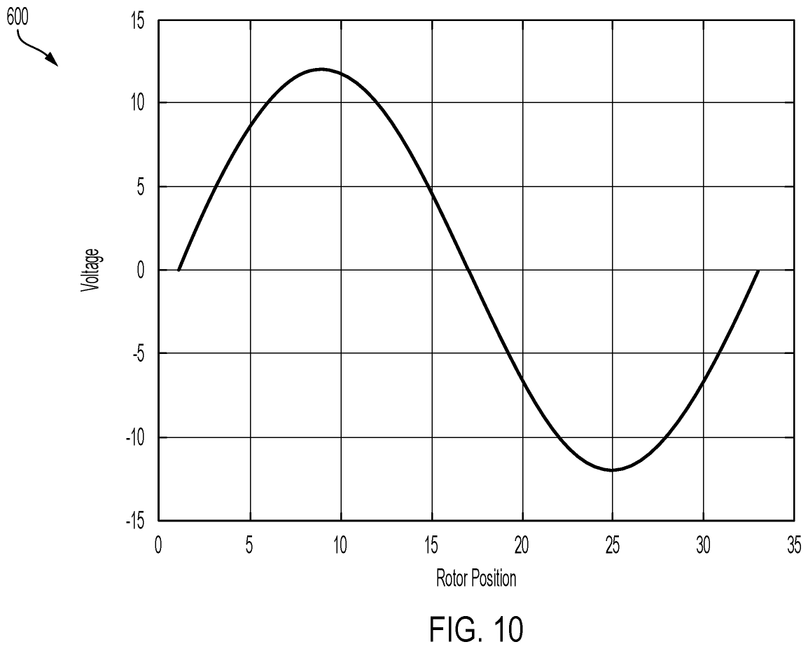

Referring now to FIG. 10, an example of one such output 600 of the cell 2003 of FIG. 9 is depicted in accordance with at least one non-limiting aspect of the present disclosure. According to the non-limiting aspect of FIG. 10, the motor clock 504 (FIG. 9) can be used by the cells 2003 (FIG. 2) to determine and/or scale an output, such that each cell 2003 (FIG. 2) outputs coherent waveform 600 that, when added up, generates an overall system output that corresponds to the particular phase of the motor 2004 (FIG. 9). According to the non-limiting aspect of FIG. 10, the output 600 of the cell 2003 (FIG. 9) can vary in a sinusoidal curve as the motor 2004 (FIG. 9) rotates. However, it shall be appreciated that the regulated output 600 of FIG. 10 is merely illustrative. According to other non-limiting aspects, the cell 2003 of FIG. 9 can be alternately configured to provide other regulated outputs to the motor 2004 (FIG. 9) in accordance with system level and/or motor design. In the case of braking, wherein the cell 2003 (FIG. 9) is regulating inputs, the cell 2003 (FIG. 9) can receive input from the motor control unit 2007, the motor clock 504 generated by the monitoring system 505—to coherently sink the desired input current and/or voltage based on the motor 2004 (FIG. 9) phase.

As with the motoring mode, the cell 2003 (FIG. 9) can regulate the current and/or voltage per the motor 2004 (FIG. 9) position and the scaling unit 512 (FIG. 9) can similarly scale inputs from the regenerative braking system 2008 (FIG. 2). For example, when brakes 2008 (FIG. 2) are applied, the power bank management system 2005 (FIG. 2) can instruct the cells 2003 (FIG. 2) to switch to a braking mode table of electrical configurations 503₁₋ₙ, and generate a desired motor brake timing using the same synchronization techniques listed above and/or a separate real-time signal generated to indicate the brakes 2008 (FIG. 2) were applied. The scaling unit 512 (FIG. 9) of the cell 2003 (FIG. 9) can factor the required response (per the phase) for braking depending on the required amount of deceleration. In some aspects, the cell 2003 (FIG. 2) can have a shunt resister configured to dissipate excessive energy generated by the regenerative braking system 2008 (FIG. 2), instead of and/or in addition to using such energy to charge the cell 2003 (FIG. 9). In other words, if the state of charge for any particular cell 2003 (FIG. 2) is high and it cannot consume the generated energy, the cell 2003 (FIG. 9) may distribute the energy to its shunt resistor.

For some types of motors (e.g., an AC induction motor), the motor clock 504 of the motor control unit 2007 (FIG. 2) can also serve as a mechanism to actively control slip angle (e.g., an angle between the actual rotor speed and the voltage and/or current frequency driving the motor). According to some non-limiting aspects, slip angle can be controlled by applying a scale/time-offset value to motor clock 504 output signal before sending it to the cell 2003 (FIG. 9). The motor control unit 2007 (FIG. 2) can be configured to maintain constant power, constant torque, and/or constant RPM modes of the motor 2004 (FIG. 9). Based on current and/or voltage supplied on each phase and the changes in motor clock frequency, the motor control unit 2007 (FIG. 2) can calculate the new scaling factor and communicate it to the cells.

For example, according to some non-limiting aspects, in case of constant power control loop, the vector sum of supplied current per phase is used to calculate torque, while the motor clock is used to calculate RPM. The control loop aims to maintain the product of torque and RPM constant and calculates the scaling factors (per phase) to achieve this. In case of constant torque, the control loop aims to maintain the vector sum of the supplied currents per phrase constant and calculates the scaling factors (per phase) to achieve this. In case of constant RPM, the control loop aims to maintain the motor clock frequency constant and calculates the scaling factors to achieve this. In other words, dynamic changes in load can be tracked at run time, which enables better estimation of rotor position based on load changes which can affect the rotor acceleration and/or deceleration. In case of braking, each cell 2003 (FIG. 2) can use the motor clock 504 (FIG. 9) to coherently sink the desired input current and/or voltage that corresponds to the communicated rotor position of the motor 2004, as shown in FIG. 9.

As with the motoring mode, each cell 2003 (FIG. 9) can maintain the current and/or voltage value per rotor position as well as scaling factor for braking mode. When brakes are applied, it instructs all cells 2003 (FIG. 2) to switch to a braking mode table, wherein each electrical configuration 503ₙ₋₁ (FIG. 9) corresponds to a desired cell operation for braking. This creates the desired motor 2004 (FIG. 9) brake timing either using the same synchronization techniques listed above or, according to some non-limiting aspects, as a separate real-time signal that can be either dedicated to indicate brake or as special signal on motor clock to indicate the change to brake mode. The scaling factors (per phase) for braking depend on the required amount of deceleration. As previously noted, according to some non-limiting aspects, the cell 2003 (FIG. 9) can have a shunt resister. This shunt resistor can be used to dissipate the excessive energy, instead of, or in addition to, using it to charge the battery cell, assuming the “state of charge” for the cell is high and thus, the cell 2003 (FIG. 2) cannot consume the required amount of energy. This approach enables antilock brake system (“ABS”)-like functionality by controlling the brake force by allowing the tires to rotate enough to optimize the tires slip ratio for maximum friction. More advanced braking can be achieved when each wheel is driven by independent motor or even having front and back wheels driven by the corresponding motors. In this cases separate scaling factor can be applied based on slipping ratio on each tire controlled by a motor.

Starting the motor can be controlled by the motor control unit 2007 (FIG. 2) and might, according to some non-limiting aspects, follow a separate voltage and/or current table including a different array of electrical configurations 503ₙ₋₁ (FIG. 9), since the rotor position estimator might have less precision. The motor dock 504 (FIG. 9) might have less pulses per rotation period. The switch between “starting” and ‘motoring’ modes can be done via the cell 2003 (FIG. 3) communication protocols and/or a dedicated sequence on the motor clock 504 (FIG. 9) signal. The various aspects of the present disclosure can be applicable to and beneficial for any type of the electric motor 2004 (FIG. 9) currently used in electric vehicles, including alternating current, permanent magnet, and/or brushless direct current motors, amongst others.

Referring now to FIGS. 11A-C, several schematics illustrating the precise motor 2004 (FIG. 9) tracking capabilities of the motor control unit 2007 of FIG. 2 are depicted in accordance with at least one non-limiting aspect of the present disclosure. For example, according to the non-limiting aspect of FIG. 11A, the motor monitoring system 505 (FIG. 9) has tracked the position of the motor 2004 at position A at T₀, as determined by the motor clock 504 (FIG. 9). According to the non-limiting aspect of FIG. 11B, the motor monitoring system 505 (FIG. 9) has tracked the position of the motor 2004 at position B at T₀+ΔT, as determined by the motor clock 504 (FIG. 9). According to the non-limiting aspect of FIG. 11C, the motor monitoring system 505 (FIG. 9) has tracked the position of the motor 2004 at position C at T₀+2*ΔT, as determined by the motor clock 504 (FIG. 9). The motor monitoring system 505 (FIG. 9) can track the various positions A, B, C of the motor 2004 via a sensor (e.g., optical, hall, etc.), a decoder, and/or an electromotive force measurement device, amongst other devices configured to estimate a position of the rotor of the motor 2004 at a particular time resulting in generating the motor clock 504 (FIG. 9).

In further reference to FIGS. 11A-C, the motor control unit 2007 (FIG. 9) can precisely determine the position of the motor and the motor logic 506 (FIG. 9) can determine the phase of the motor 2004 based on the smallest angular movement of a rotor of the motor 2004 that can be tracked by the monitoring system 505 (FIG. 9). According to FIGS. 11A-C, this angular movement is illustrated by positions A, B, C. For example, according to some non-limiting aspects, the smallest angular movement of the rotor may be 7.5 degrees, meaning the motor control unit 2007 (FIG. 2) can track up to 48 rotor positions per full rotation. A full rotation of the rotor is a 360 degree revolution about an axis of the motor 2004. In other words, the motor clock 504 (FIG. 9) can interface with and convey the rotor position to the cell 2003 (FIG. 9) approximately 48 times during a full rotation of the rotor. As such, the powertrain 2000 (FIG. 2) and more specifically, the cell 2003 (FIG. 9) can generate 48 different outputs 600 (FIG. 10), wherein each output 600 (FIG. 10) corresponds to a phase of the motor 2004 (FIG. 9), or position of the rotor. According to other non-limiting aspects, the smallest angular movement of the rotor can be altered such that the motor control unit 2007 (FIG. 2) can track any number of rotor positions per rotation. As such, the powertrain 2000 (FIG. 2) can be configured to scale and manage cell outputs 600 (FIG. 10), rack outputs 3304 (FIG. 7), and/or overall outputs 3304 (FIG. 7) of the system 2000 (FIG. 2) with a high degree of precision.

The same concepts apply to using the regenerative braking system 2008 (FIG. 2) to stop the motor 2004 (FIG. 9). In this case, each cell 2003 (FIG. 2) can be configured to sink the voltage and/or current applied to each phase of the motor 2004 (FIG. 9) as a function of the exact rotor position. The motor clock 504 (FIG. 9) can be similarly utilized for braking. For example, the motor clock 504 (FIG. 9) can track the rotor position A, B. C, as depicted in FIGS. 11A-C, and the cell 2003 (FIG. 9) can scale its output in order to slow the rotor down.

According to other non-limiting aspects, the motor control unit 2007 can employ an interpolation algorithm that produces even high resolution rotor estimates beyond the tracking capabilities of the rotor monitoring system 505 (FIG. 9), by estimating a rotor parameter (e.g., speed, acceleration, inertia, load hysteresis, etc.) based on sensed metrics, such as position A, B, C relative to times determined by the motor clock 504 (FIG. 9).

The most popular electric motors (e.g., alternating current, brushless direct current, permanent direct current, etc.) are rotated by electric power being applied to three phases of the motor 2004 (FIGS. 2 and 9). To achieve the efficient rotation, this power needs to be applied in controlled and timely fashion with respect to the current rotor position. The rotor position can be obtained from the monitoring system 505 (FIG. 9), or based on the real-time measurement of the power through the phases of the motor 2004 (FIGS. 2 and 9). The rotor position estimation can further be refined based on the previous rotation information, rotor inertia and other factors.

According to the typical powertrain 100 of FIG. 1, a motor control unit 2007 (FIGS. 2 and 9), or an equivalent thereof, would be decoupled from an equivalent energy storage system 2002 (FIG. 2). The typical powertrain 1100 (FIG. 1) typically generates a DC output in the levels of hundreds of volts, and then a separate independent motor controller is used to deliver generated energy from an equivalent storage system to the motor, which has to manage such high voltage and/or current levels independently. However, the enhanced powertrain 2000 of FIG. 2 provides advantages by utilizing enhanced, “smart” cells 2003 and integrating the motor control unit 2007 and the energy storage system 2002 (FIG. 2), as is described in PCT/US2020/029108. This allows for a controlled and timed generation of power at the energy storage system 2002 (FIG. 2). The power generated by each cell 2003 (FIG. 2) of the energy storage system 2002 (FIG. 2) gets added up to the overall output and is delivered in accordance with each phase of the motor 2004 (FIGS. 2 and 9). This approach makes it possible to more efficiently respond to motor 2004 (FIGS. 2 and 9) dynamic load and/or speed requirements. This should allow an increase in efficiency as well as a potential decrease in cost and complexity of the typical powertrain 100 (FIG. 1), since the storage element generates with lower voltage/current levels (e.g., 4V/5 A) and faster switches can be used at these levels.

Various aspects of the present disclosure describe the integration of the motor control unit 2007 (FIGS. 2 and 5) as well as most of the other functions of the typical powertrain 100 (FIG. 1) within the self-contained energy storage system 2002 (FIG. 2). As a result, this makes the enhanced powertrain 2000 (FIG. 2) operate more efficiently and streamlines the overall system design. As shown on FIG. 2, the powertrain 2000 (FIG. 2) can utilize the energy storage system 2002 (FIG. 2) and directly couple it to the motor 2004 (FIG. 2). For example, the energy storage system 2002 (FIG. 2) can be divided into three power racks of cells 2003 (FIG. 2), wherein each of the racks of cells 2003 (FIG. 2) can be dedicated to driving a particular phase of the motor 2004 (FIG. 2). This can work with all electric vehicle motors 2004 (e.g., alternating current, brushless direct current, permanent direct current, etc.), both with and without sensors. If the chosen motor 2004 (FIG. 2) has sensors, they should be connected to the motor control unit 2007 (FIGS. 2 and 9) in lieu of or in conjunction with the motor monitoring system 505 (FIG. 9). In order to charge the energy storage system 2002 (FIG. 2), the cells 2003 (FIG. 2) should be connected to the charge rails, as described in PCT/US2020/029108.

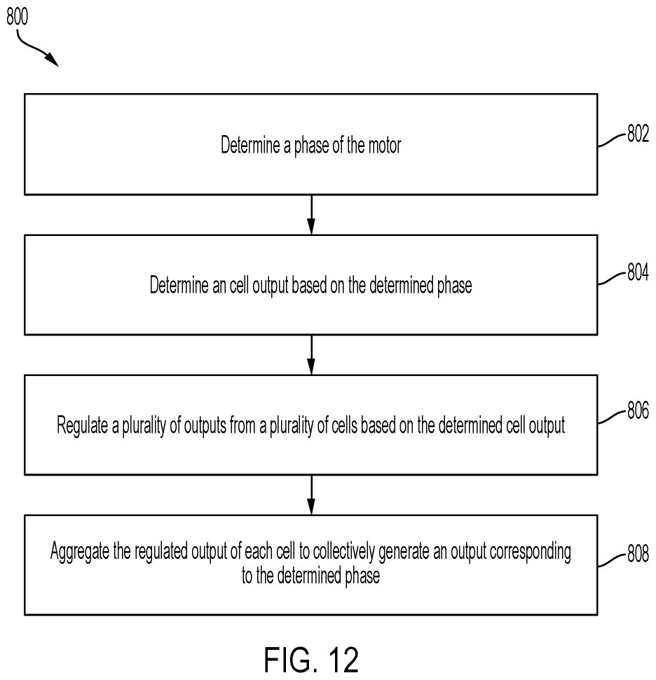

Referring now to FIG. 12, a flow diagram of a method 800 of managing the energy output of a powertrain of an electric vehicle is depicted in accordance with at least one non-limiting aspect of the present disclosure. According to the non-limiting aspect of FIG. 12, the method 800 can include determining 802, via the motor control unit 2007 (FIGS. 2 and 9), a phase of the motor 2004 (FIGS. 2 and 9); determining 804, via motor phase logic 506 (FIG. 9), a cell 2003 (FIG. 9) output based, at least in part, on the determined phase of the motor 2004 (FIGS. 2 and 9) and a cell configuration table 503₁₋ₙ; regulating 806, via a plurality of regulators 514 (FIG. 9) of a plurality of cells 2003 (FIG. 9), an output of each cell 2003 (FIG. 9) of the plurality of cells 2003 (FIG. 9) based, at least in part, on the cell configuration table 503r-n; and aggregating 808, via the power bank management unit 2005 (FIG. 2), the regulated output of each cell 2003 (FIG. 2) of the plurality of cells 2003 (FIG. 9), such that the subset collectively generates an output that equals an overall power output corresponding to the determined phase.

Referring now to FIG. 13, a block diagram of a scalable energy storage system 900 is depicted in accordance with at least one non-limiting aspect of the present disclosure. According to the non-limiting aspect of FIG. 13, the scalable energy storage system 900 can include one or more power racks 902_{a-c} coupled to the motor control unit 2007, wherein each of the one or more power racks 902_{a-c}, can integrate one or more power banks (e.g., the power banks 104 of FIG. 3). Accordingly, each power rack 902_{a-c} can include a power bank management unit 904_{a-c} and, according to some non-limiting aspects, one or more power bank management units 904_{a-c} can be assigned to perform the previously disclosed functions of the motor controller 2007. In other words, one or more power bank management units 904_{a-c} can track and/or estimate the rotor position based on the information from sensors or real-time measurement of power through the phases (A, B. C) of motor 2004. For example, as shown in FIG. 13, the motor controller 2007 receives the position of the motor 2004 rotor via a rotor position sensor and the motor controller 2007 provides the motor clock to each of the power racks 902_{a-c}. According to some non-limiting aspects, the power bank management unit 904_{a-c} also can receive information about the desired speed and/or acceleration of the motor 2004.

Based on this, each power bank management unit 904_{a-c} will communicate to the storage elements the desired amount of power to be delivered at every position of the rotor. This communication can be performed via the cell communication protocol described above. However, to properly time the power delivery as a function of the rotor position, there should be a mechanism capable of communicating the rotor position information instantly to all the storage elements throughout the system. This mechanism can be a motor clock, as described above. The entire rotor's revolution can be divided into the number of equal phases or arcs, as depicted in FIGS. 11A-C. The number of phases can define the motor clock precision. For example, if the number of phases is 48, the motor clock precision is 7.5 degrees. The motor clock can be a series link that communicates each phase of rotor's revolution by encoding and sending it over this series link. The way of encoding can vary. For example, the 0 degrees (12 o'clock) rotor position can be communicated as a longer pulse while all the other 47 positions—as a shorter pulse. Upon receiving the motor clock event, each energy storage element generates the power required at this phase of the rotor's revolution.

Various aspects of the subject matter described herein are set out in the following numbered clauses:

Clause 1: A powertrain for an electric vehicle, including an electric motor; an energy storage system electrically coupled to the electric motor, wherein the energy storage system includes: a motor control unit configured to determine a phase of the electric motor; a plurality of cells, wherein each cell of the plurality of cells is configured to: determine a discrete power output based, at least in part, on the determined phase of the electric motor; and generate the determined discrete power output; and a power bank management unit configured to: determine an overall power output based, at least in part, on the determined phase of the electric motor; determine a subset of the plurality of cells based, at least in part, on the overall power output; and command each cell of the subset of the plurality of cells to generate the discrete power output, the subset of the plurality of cells is configured to collectively generate an output equal to the overall power output.

Clause 2: The powertrain according to clause 1, wherein the electric motor includes a rotor, and wherein the electric motor control unit is configured to determine the phase of the motor based, at least in part, on a position of the rotor.

Clause 3: The powertrain according to clauses 1 or 2, wherein the motor control unit includes a rotor monitoring system configured to determine the position of the rotor.

Clause 4: The powertrain according to any of clauses 1-3, wherein the rotor monitoring system includes at least one of: an optical sensor, a hall effect sensor, a decoder, or an electromotive force measurement device, or any combination thereof.

Clause 5: The powertrain according to any of clauses 1-4, wherein the rotor monitoring system is configured to determine an angular movement of the rotor.

Clause 6: The powertrain according to any of clauses 1-5, wherein the angular movement of the rotor is 7.5 degrees, and wherein the motor control unit is configured to track 48 discrete positions of the rotor.

Clause 7: The powertrain according to any of clauses 1-6, wherein the motor control unit further includes a motor clock, and wherein the motor control unit is further configured to determine the phase of the motor based, at least in part, on a time calculated by the motor clock.

Clause 8: The powertrain according to any of clauses 1-7, wherein the motor control unit is further configured to determine a second phase of the electric motor.

Clause 9: The powertrain according to any of clauses 1-8, wherein the power bank management unit is further configured to: determine a second overall power output based, at least in part, on the determined second phase of the electric motor; determine a second subset of the plurality of cells based, at least in part, on the overall second power output; and command each cell of the subset of the plurality of cells to generate the discrete power output, the second subset of the plurality of cells is configured to collectively generate a second output equal to the second overall power output, wherein the second overall power output is different from the overall power output.

Clause 10: The powertrain according to any of clauses 1-9, further including a regenerative braking system.

Clause 11: The powertrain according to any of clauses 1-10, wherein the power bank management unit is further configured to: determine a third overall power output based, at least in part, on an input received from the regenerative braking system; determine a third subset of the plurality of cells based, at least in part, on the third overall power output; and command each cell of the third subset of the plurality of cells to generate the discrete power output, the subset of the plurality of cells is configured to collectively generate a third output equal to the overall power output, wherein the third overall power output is different from the overall power output and the second overall power output.

Clause 12: An energy storage system configured for use with a powertrain of an electric vehicle, the energy storage system including: a motor control unit configured to determine a phase of a motor electrically coupled to the energy storage system; a plurality of cells, wherein each cell of the plurality of cells is configured to: determine a discrete power output based, at least in part, on the determined phase of the motor; and generate the determined discrete power output; and a power bank management unit configured to: determine an overall power output based, at least in part, on the determined phase of the motor; determine a subset of the plurality of cells based, at least in part, on the overall power output; and command each cell of the subset of the plurality of cells to generate the discrete power output, the subset of the plurality of cells is configured to collectively generate an output equal to the overall power output.

Clause 13: The energy storage system according to clause 12, wherein the motor control unit is configured to determine the phase of the motor based, at least in part, on a position of a rotor of the motor.

Clause 14: The energy storage system according to either of clauses 12 and 13, wherein the motor control unit includes a rotor monitoring system configured to determine the position of the rotor.

Clause 15: The energy storage system according to any of clauses 12-14, wherein the motor control unit further includes a motor clock, and wherein the motor control unit is further configured to determine the phase of the motor based, at least in part, on a time calculated by the motor clock.

Clause 16: The energy storage system according to any of clauses 12-15, wherein the motor control unit is further configured to determine a second phase of the motor.

Clause 17: The energy storage system according to any of clauses 12-16, wherein the power bank management unit is further configured to: determine a second overall power output based, at least in part, on the determined second phase of the motor; determine a second subset of the plurality of cells based, at least in part, on the overall second power output; and command each cell of the subset of the plurality of cells to generate the discrete power output, the second subset of the plurality of cells is configured to collectively generate a second output equal to the second overall power output, wherein the second overall power output is different from the overall power output.

Clause 18: A method of managing an energy output of a powertrain of an electric vehicle via an energy storage system, wherein the powertrain includes a motor electrically coupled to the energy storage system, and wherein the energy storage system includes a motor control unit and a power bank management unit, and a plurality of cells configured to generate a discrete power output, the method including: determining, via the motor control unit, a phase of the motor; determining, via motor phase logic, a cell output based, at least in part, on the determined phase of the motor and a cell configuration table; regulating, via a plurality of regulators within the plurality of cells, an output of each cell of the plurality of cells based, at least in part, on the determined cell output; and aggregating, via the power bank management unit, the regulated output of each cell of the plurality of cells, such that the subset collectively generates an output that equals an overall power output corresponding to the determined phase.

Clause 19: The method according to clause 18, wherein the motor includes a rotor, wherein the motor control unit includes a motor clock and a rotor monitoring system configured to determine a position of the rotor, and wherein determining, via the motor control unit, the phase of the motor is further based on the position of the rotor and a time calculated by the motor clock.

Clause 20: The method according to either of clauses 18 or 19, further including: determining, via the motor control unit, a second phase of the motor; determining, via motor phase logic, a second cell output based, at least in part, on the determined second phase of the motor; regulating, via the plurality of regulators within the plurality of cells, a second output of each cell of the plurality of cells based, at least in part, on the determined second cell output; and aggregating, via the power bank management unit, the regulated output of each cell of the plurality of cells, such that the subset collectively generates an output that equals a second overall power output corresponding to the determined second phase of the motor.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present disclosure has been described with reference to various examples and illustrative aspects. The aspects described herein are understood as providing illustrative features of varying detail of various aspects of the present disclosed; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications or combinations of any of the example aspects may be made without departing from the scope of the present disclosure. In addition, persons skilled in the art will recognize, or be able to ascertain using no more than routine experimentation, many equivalents to the various aspects of the present disclosure described herein upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain. such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component.” “system.” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining.” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

The terms “proximal” and “distal” are used herein with reference to a clinician manipulating the handle portion of the surgical instrument. The term “proximal” refers to the portion closest to the clinician and the term “distal” refers to the portion located away from the clinician. It will be further appreciated that, for convenience and clarity, spatial terms such as “vertical”, “horizontal”, “up”, and “down” may be used herein with respect to the drawings. However, surgical instruments are used in many orientations and positions, and these terms are not intended to be limiting and/or absolute.

What is claimed is:

1. A powertrain for an electric vehicle, comprising:
an electric motor;
an energy storage system electrically coupled to the electric motor, wherein the energy storage system comprises:
a motor control unit configured to determine a phase of the electric motor;
a plurality of cells, wherein each cell of the plurality of cells is configured to:
determine a discrete power output based, at least in part, on the determined phase of the electric motor; and
generate the determined discrete power output; and
a power bank management unit configured to:
determine an overall power output based, at least in part, on the determined phase of the electric motor;
determine a subset of the plurality of cells based, at least in part, on the overall power output; and
command each cell of the subset of the plurality of cells to generate the discrete power output, the subset of the plurality of cells is configured to collectively generate an output equal to the overall power output.

2. The powertrain of claim 1, wherein the electric motor comprises a rotor, and wherein the motor control unit is configured to determine the phase of the electric motor based, at least in part, on a position of the rotor.

3. The powertrain of claim 2, wherein the motor control unit comprises a rotor monitoring system configured to determine the position of the rotor.

4. The powertrain of claim 3, wherein the rotor monitoring system comprises at least one of: an optical sensor, a hall effect sensor, a decoder, or an electromotive force measurement device, or any combination thereof.

5. The powertrain of claim 3, wherein the rotor monitoring system is configured to determine an angular movement of the rotor.

6. The powertrain of claim 5, wherein the angular movement of the rotor is 7.5 degrees, and wherein the motor control unit is configured to track 48 discrete positions of the rotor.

7. The powertrain of claim 3, wherein the motor control unit further comprises a motor clock, and wherein the motor control unit is further configured to determine the phase of the electric motor based, at least in part, on a time calculated by the motor clock.

8. The powertrain of claim 1, wherein the motor control unit is further configured to determine a second phase of the electric motor.

9. The powertrain of claim 8, wherein the power bank management unit is further configured to:
determine a second overall power output based, at least in part, on the determined second phase of the electric motor;
determine a second subset of the plurality of cells based, at least in part, on the overall second power output; and
command each cell of the subset of the plurality of cells to generate the discrete power output, the second subset of the plurality of cells is configured to collectively generate a second output equal to the second overall power output, wherein the second overall power output is different from the overall power output.

10. The powertrain of claim 9, further comprising a regenerative braking system.

11. The powertrain of claim 10, wherein the power bank management unit is further configured to:
determine a third overall power output based, at least in part, on an input received from the regenerative braking system;
determine a third subset of the plurality of cells based, at least in part, on the third overall power output; and
command each cell of the third subset of the plurality of cells to generate the discrete power output, the subset of the plurality of cells is configured to collectively generate a third output equal to the overall power output, wherein the third overall power output is different from the overall power output and the second overall power output.

12. An energy storage system configured for use with a powertrain of an electric vehicle, the energy storage system comprising:
a motor control unit configured to determine a phase of a motor electrically coupled to the energy storage system;
a plurality of cells, wherein each cell of the plurality of cells is configured to:
determine a discrete power output based, at least in part, on the determined phase of the motor; and
generate the determined discrete power output; and
a power bank management unit configured to:
determine an overall power output based, at least in part, on the determined phase of the motor;
determine a subset of the plurality of cells based, at least in part, on the overall power output; and
command each cell of the subset of the plurality of cells to generate the discrete power output, the subset of the plurality of cells is configured to collectively generate an output equal to the overall power output.

13. The energy storage system of claim 12, wherein the motor control unit is configured to determine the phase of the motor based, at least in part, on a position of a rotor of the motor.

14. The energy storage system of claim 13, wherein the motor control unit comprises a rotor monitoring system configured to determine the position of the rotor.

15. The energy storage system of claim 14, wherein the motor control unit further comprises a motor clock, and wherein the motor control unit is further configured to determine the phase of the motor based, at least in part, on a time calculated by the motor clock.

16. The energy storage system of claim 15, wherein the motor control unit is further configured to determine a second phase of the motor.

17. The energy storage system of claim 16, wherein the power bank management unit is further configured to:
determine a second overall power output based, at least in part, on the determined second phase of the motor;
determine a second subset of the plurality of cells based, at least in part, on the overall second power output; and
command each cell of the subset of the plurality of cells to generate the discrete power output, the second subset of the plurality of cells is configured to collectively generate a second output equal to the second overall power output, wherein the second overall power output is different from the overall power output.

18. A method of managing an energy output of a powertrain of an electric vehicle via an energy storage system, wherein the powertrain comprises a motor electrically coupled to the energy storage system, and wherein the energy storage system comprises a motor control unit and a power bank management unit, and a plurality of cells configured to generate a discrete power output, the method comprising:
determining, via the motor control unit, a phase of the motor;
determining, via motor phase logic, a cell output based, at least in part, on the determined phase of the motor and a cell configuration table;
regulating, via a plurality of regulators within the plurality of cells, an output of each cell of the plurality of cells based, at least in part, on the determined cell output; and
aggregating, via the power bank management unit, the regulated output of each cell of the plurality of cells, such that the subset collectively generates an output that equals an overall power output corresponding to the determined phase.

19. The method of claim 18, wherein the motor comprises a rotor, wherein the motor control unit comprises a motor clock and a rotor monitoring system configured to determine a position of the rotor, and wherein determining, via the motor control unit, the phase of the motor is further based on the position of the rotor and a time calculated by the motor clock.

20. The method of claim 18, further comprising:
determining, via the motor control unit, a second phase of the motor;
determining, via motor phase logic, a second cell output based, at least in part, on the determined second phase of the motor;
regulating, via the plurality of regulators within the plurality of cells, a second output of each cell of the plurality of cells based, at least in part, on the determined second cell output; and
aggregating, via the power bank management unit, the regulated output of each cell of the plurality of cells, such that the subset collectively generates an output that equals a second overall power output corresponding to the determined second phase of the motor.
